(19) United States
(12) Patent Application Publication
(10) Pub. No.: US 2006/0206831 A1
(43) Pub. Date: Sep. 14, 2006

(54) Methods and apparatus providing custom analysis of test and measurement data

(76) Inventors: Douglas James Beck, Colorado Springs, CO (US); Cheryl Brown Fincher, Colorado Springs, CO (US); Eric James Kuzara, Colorado Springs, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/080,266

(22) Filed: Mar. 14, 2005

(51) Int. Cl. G06F 3/00; G06F 19/00

(52) U.S. Cl. 715/764; 702/1

(57) ABSTRACT

In one embodiment, a computer program distributed by a first party is provided with: code to determine whether a second party has defined a custom analysis of test and measurement (T&M) data and then provide access to the custom analysis via a graphical user interface (GUI); and code to, upon a user's selection of the custom analysis via the GUI, 1) execute custom code provided by the second party, and 2) display the custom analysis within a window of the GUI, in a format dictated by the execution of the custom code.

### BACKGROUND

Test and measurement (T&M) applications such as those that interface with logic analyzers or oscilloscopes are often capable of acquiring T&M data and displaying a number of standard analyses of the T&M data. However, end users of T&M applications often want to view custom analyses of T&M data (e.g., an analysis that is specific to the user's device under test, or an analysis that is not commonly used).

To generate and view a custom analysis, an end user typically needs to purchase, author or commission analysis software that is separate and distinct from the T&M application. In some cases, the analysis software may be able to retrieve T&M data via an interface (e.g., an application programming interface (API)) of the T&M application used to acquire the T&M data. However, in many cases, the analysis software may only obtain T&M data from a data store.

### SUMMARY OF THE INVENTION

In one embodiment, a computer program distributed by a first party comprises: code to determine whether a second party has defined a custom analysis of test and measurement (T&M) data and then provide user access to the custom analysis via a graphical user interface (GUI); and code to, upon a user's selection of the custom analysis via the GUI, 1) execute custom code provided by the second party, and 2) display the custom analysis within a window of the GUI, in a format dictated by the execution of the custom code.

In another embodiment, a method of enabling a T&M application to display a custom analysis of T&M data comprises providing the T&M application with a plurality of display elements. The display elements include a first window type for displaying a standard analysis of the T&M data, an interface for specifying and saving custom code that defines the custom analysis, and a second window type for displaying the custom analysis in a format dictated by execution of the custom code. The method further comprises providing the T&M application with at least one GUI via which the display elements may be selected and displayed.

In yet another embodiment, a method for displaying a custom analysis of T&M data comprises choosing from between a custom analysis and a standard analysis that are selectable via a GUI of a T&M application. Upon selection of the standard analysis, the T&M application is caused to execute compiled code, the execution of which causes the T&M application to display a standard analysis window within the GUI. Upon selection of the custom analysis, the T&M application is caused to execute custom, interpreted code, the execution of which causes the T&M application to display a custom analysis window within the GUI.

Other embodiments are also disclosed.

### BRIEF DESCRIPTION OF THE DRAWINGS

Illustrative embodiments of the invention are illustrated in the drawings, in which:

FIG. 1 illustrates an exemplary method for enabling a test and measurement T&M application to display a custom analysis of T&M data;

FIG. 2 illustrates a GUI in which four different analysis windows have been launched, two of which are based on standard analyses of T&M data, and two of which are based on custom analyses of T&M data;

FIG. 3 illustrates the display of an alternate custom analysis through the GUI introduced in FIG. 2;

FIG. 4 provides a model of a T&M application that is coded in accordance with the method shown in FIG. 1;

FIG. 5 illustrates the arrangement of an exemplary computer program that, depending on its configuration, may be used to carry out some or all of the method shown in FIG. 1, as well as other functions;

FIG. 6 illustrates an exemplary method for displaying a custom analysis of test and measurement (T&M) data; and

FIG. 7 provides a model of how past T&M applications have been viewed by their users.

### DETAILED DESCRIPTION

In the past, a T&M application has sometimes been provided with an ability to generate one or more standard analyses. However, the code for generating these analyses is part of the compiled T&M application and cannot be modified or supplemented by a third party software developer (who is sometimes the application's end user). As a result, if a user wants to view a custom analysis of T&M data (e.g., an analysis of T&M data that is specific to the user's device under test (such as a timing verification between signals of a proprietary bus), or an analysis of T&M data that is not commonly used), the software developer must purchase, author or commission analysis software that is separate and distinct from the T&M application. Separate and distinct applications can be undesirable in that they need to be separately installed and maintained; and a user must learn two different application interfaces, each of which will likely have a different look-and-feel.

A model 700 of how past T&M applications 702 have been viewed by their users is provided in FIG. 7. As illustrated, the model 700 comprises stand-alone T&M and custom analysis applications 702, 704, each of which accesses a T&M data source 706 (e.g., a data store). As indicated above, a downside to this approach is that a user must install and learn two different applications, each of which has a different look-and-feel. The software developer must also provide a lot of infrastructure that is duplicative of that provided by the T&M application. This is inefficient.

While some existing T&M applications allow a user to write a customized script for manipulating T&M data, these scripts merely manipulate or aggregate data prior to displaying it using a standard analysis window.

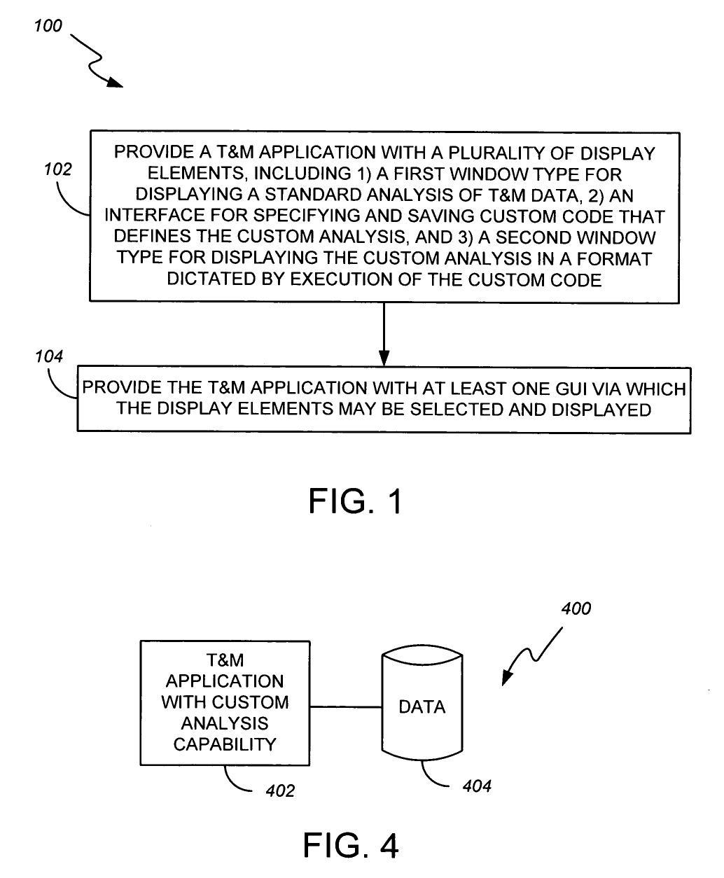

FIG. 1 illustrates an exemplary method 100 for enabling a test and measurement (T&M) application to display a custom analysis of T&M data. The method 100 comprises providing 102, 104 the T&M application with a plurality of display elements and at least one graphical user interface (GUI) via which the display elements may be selected and displayed. The display elements may take various and numerous forms, including those of 1) a first window type for displaying a standard analysis of the T&M data, 2) an interface for specifying and saving custom code that defines a custom analysis, and 3) a second window type for displaying the custom analysis in a format dictated by the execution of the custom code. Preferably, the first and second window types are provided with a common look-and-feel, thereby making it difficult, if not impossible, to determine whether a generated analysis is standard or custom.

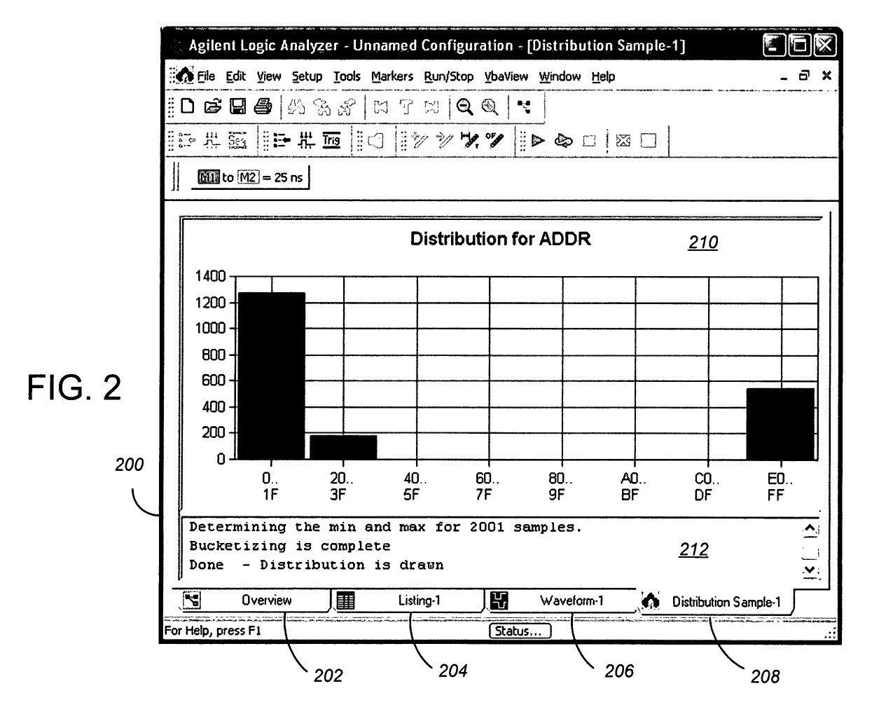

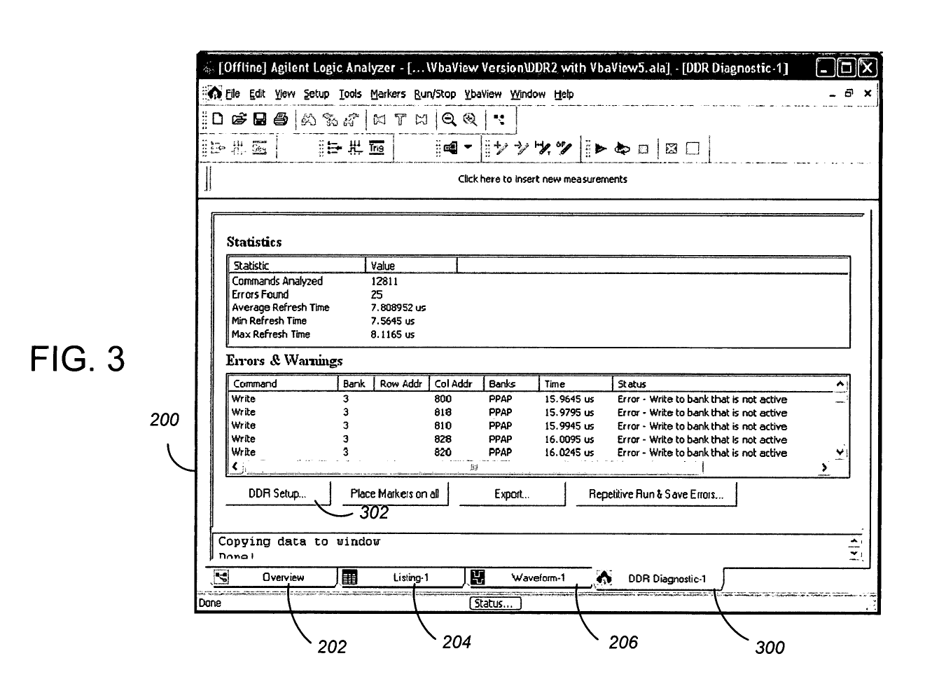

In one embodiment, the method 100 provides a T&M application with an ability to launch multiple instances of the first or second window type, with each launched instance displaying a different standard or custom analysis of T&M data. By way of example, FIG. 2 illustrates a GUI 200 in which four different analysis windows have been launched, two of which 202, 204 are based on standard analyses of T&M data, and two of which 206, 208 are based on custom analyses of T&M data. By way of example, the active window 208 displays a custom analysis including both graphical 210 (e.g., a graph) and textual 212 information. However, other custom analysis windows may display only graphical or textual information. See the custom analysis 300 for the later (FIG. 3).

To generate a window 208 or 300 displaying a custom analysis, the GUI 200 from which the custom analysis is selected may provide access to the custom analysis via a separate menu item or icon, or the GUI 200 may provide access to standard and custom analyses without providing any indication as to which is which.

A T&M application 402 that is coded in accordance with the method 100 may be modeled as shown in FIG. 4. As illustrated, the model 400 comprises a single T&M application 402 that enables a software developer or user to generate both standard and custom analyses of T&M data 404. The selection and display of standard versus custom analyses therefore appears to be “seamless” to the end user, meaning that if the end user did not create the custom analyses personally (which is typically the case), then the end user will be unaware that the analyses provided by their T&M application 402 were created by anyone other than the T&M application distributor (except, for example, that the creator of a custom analysis might be provided some sort of an acknowledgement in the form of a byline or logo that is associated with the custom analysis).

Of note, there is no reason why a T&M application developer could not create a T&M application that specifically incorporates all needed analyses into the application's compiled code. However, for many reasons, including, for example, 1) a T&M application developer's lack of resources to incorporate every possible analysis into the application (and the cost that this would add to the application), and 2) the proprietary nature of some of the devices that a user might test, the T&M application developer may be unable to proactively incorporate all necessary analyses into their T&M application. The method 100 therefore provides a means for customizing a T&M application to provide access to custom analyses through the same GUI used by the compiled “core” of the T&M application.

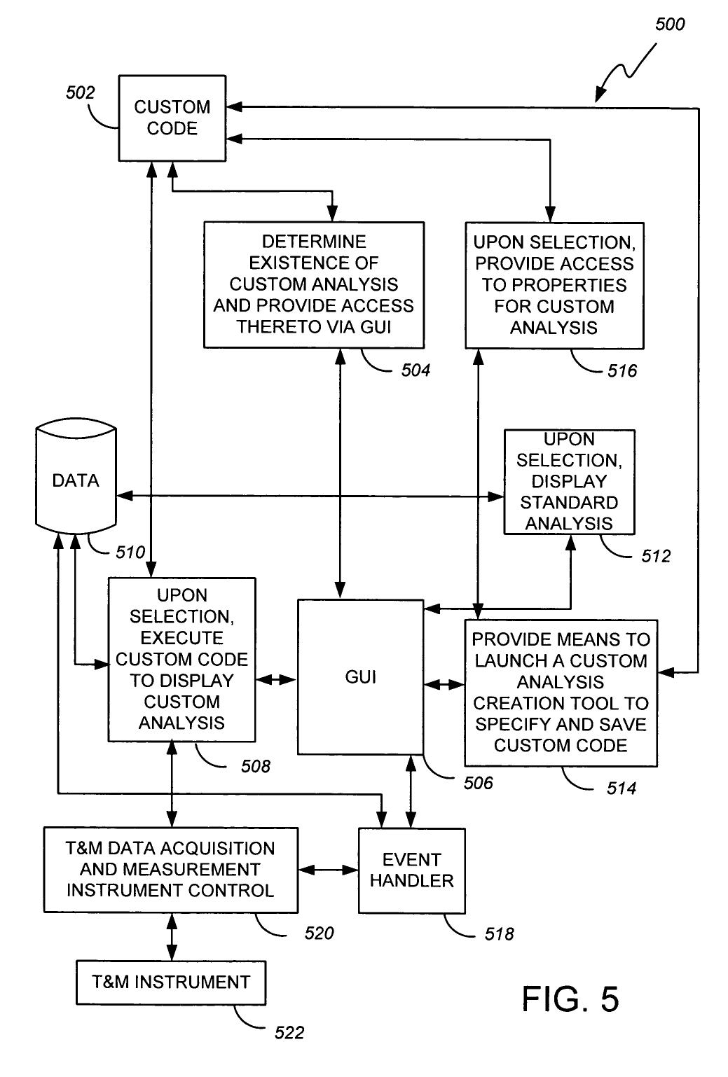

FIG. 5 illustrates the arrangement of an exemplary computer program 500 that, depending on its configuration, may be used to carry out some or all of the method 100, as well as other functions.

If the computer program 500 is presumed to be distributed by a first party (e.g., a T&M application developer), then the program 500 may comprise code 504 to 1) determine whether a second party has defined a custom analysis of T&M data 510, and 2) provide user access to the custom analysis via a graphical user interface (GUI 506). In one embodiment, access to the custom analysis is provided via a GUI menu item.

The program 500 may also comprise code 508 to, upon a user's selection of the custom analysis via the GUI 506, 1) execute custom code 502 provided by the second party, and 2) display the custom analysis within a window of the GUI 506, in a format dictated by the execution of the custom code 502. Note, however, that although the custom code 502 may dictate the format of a custom analysis, code 508 provided by the first party (e.g., code provided by the T&M application developer) may place limits on the formats that can be specified by the custom code. For example, code 508 provided the T&M application developer may only support the display of a given set of static or real-time graphs, and the custom code 502 may be limited to selecting one of the supported graphs (although another party may be able to specify any or all of the parameters for the graph, as well as any filtering, aggregation or manipulation of data that is necessary to illustrate a custom analysis using the graph).

In determining whether a second party has defined a custom analysis of T&M data 510, the program may access a particular directory or directories in which custom code defining the custom analysis needs to be stored. Alternately, the program may search for particular file types. In one embodiment, custom code 502 is stored within a Zip file in a predetermined directory, and the Zip file includes both the custom code 502 that defines the custom analysis (which code may be stored in one or more files related to, for example, window display instructions, properties dialog instructions, and a help file), as well as an information file (e.g., an XML file) that provides the T&M application with basic properties/information regarding the custom code 502.

In one embodiment, the program 500 may further comprise code 512 to provide user access to a standard analysis via the GUI 506, and code 512 to, upon a user's selection of the standard analysis via the GUI 506, display the standard analysis within a window of the GUI 506. Preferably, custom and standard analyses are displayed within different windows of the GUI 506, and some of the windows (and preferably all of them) have a common look-and-feel.

The program 500 may further comprise code 516 to provide user access to properties for the custom analysis, and upon a user's selection of the properties via the GUI 506, display the properties in a dialog box as dictated by execution of the custom code 502. Access to the properties may be provided, for example, by means of a pull-down menu, an icon, or a pop-up list that is activated by a mouse-click.

Still further, the program 500 may comprise code 514 that provides a means to launch a custom analysis creation tool from within the GUI 506. Upon selection of the custom analysis creation tool, the code 514 provides an interface for specifying and saving custom code 502 that defines a custom analysis of T&M data 510.

In one embodiment, the custom analysis creation tool implements Visual Basic for Applications, and the custom code 502 comprises Visual Basic for Applications (VBA) code. By providing an application programming interface (API), a T&M application can both expose an object model to the VBA environment and retrieve and execute VBA code. Exemplary API's include, for example, Microsoft Corporation's Component Object Model (COM) or Distributed COM (COM), or Object Management Group, Inc.'s Common Object Request Broker Architecture (CORBA)).

It is noted that VBA does not provide a standard graphing display, and it typically only provides a developer an ability to create VBA dialogs (i.e., a secondary display used to enter data). As a result, the API exposed by a T&M application may provide access to various graphic and drawing capabilities of the T&M application itself (e.g., line charts, XY scattergrams, pie charts, bar charts, and/or a web browser), which a developer can then manipulate via instructions provided in the VBA programming environment. When generating a window in response to a user's selection of a custom analysis, the T&M application then draws a window type (i.e., a “VBA window”) in which some display elements are dictated largely or solely by VBA code, and in which other elements are selected or programmed by VBA instructions (but largely provided by the T&M application). It is not necessary, however, that every VBA window include both graphical and textual information. For example, the window 300 (FIG. 3) provides a text-only custom analysis for a Double Data Rate (DDR) bus. The analysis finds functional problems in a listing of DDR commands by, for example, identifying attempts to write to banks that are not active. Note that the window 300 also provides pushbuttons (e.g., 302) via which a user may obtain access to other functionality or windows.

Other than some elements of a VBA window type being determined or influenced by VBA code, a VBA window may behave similarly to any other window type (e.g., it may be added, accessed, manipulated, drawn similarly to other window types).

VBA code is interpreted rather than compiled. Thus, in one embodiment of the program 500, the inability of developers and users to modify or append to the compiled code of a T&M application is circumvented by enabling developers and users to generate code that can be executed/interpreted by a T&M application for the purpose of displaying custom analyses through the T&M application. This also enables the T&M application to enforce certain “default” settings and features for the custom analyses, such as the colors and fonts used by window types that display the custom analyses, and the locations of properties and help selection tools.

The program 500 may also comprise code 518 (e.g., an event handler) to receive events regarding updates of T&M data 410 and provide notifications of at least some of the events to windows that display custom analyses (as well as to windows that display standard analyses). In this manner, and by way of example, a refresh of all windows may be triggered. Although the custom analysis creation tool may allow a developer or user to program a window so that it ignores certain events, such a feature would often be undesirable, as it provides for a departure from the common look-and-feel of the T&M application.

If it is desired that the T&M application be able to control and acquire data from T&M equipment 522 such as a logic analyzer, oscilloscope or other T&M instrument, the program 500 may further comprise code 520 for retrieving data from T&M equipment 522. In some cases, the program's custom analysis creation tool may allow a developer or user to provide instructions for invoking this code. For example, upon a user's selection of a custom analysis via the GUI 506, the code 520 for retrieving data from T&M equipment 522 may be launched in accordance with parameters defined by the custom code 502.

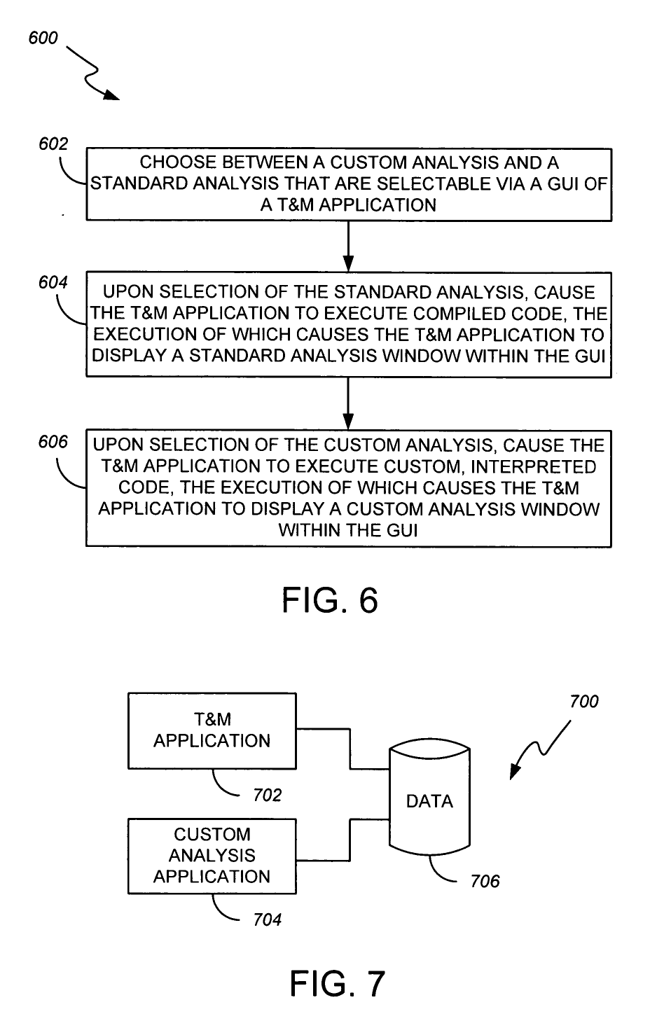

FIG. 6 illustrates an exemplary method 600 for displaying a custom analysis of test and measurement (T&M) data. In some embodiments, the method 600 may be performed using a T&M application that is designed or built in accordance with the method 100 or the program 500.

The method 600 comprises choosing 602 from between a custom analysis and a standard analysis that are selectable via a graphical user interface (GUI) of a T&M application. Upon selection of the standard analysis, the T&M application is caused 604 to execute compiled code, the execution of which causes the T&M application to display a standard analysis window within the GUI. Upon selection of the custom analysis, the T&M application is caused 606 to execute custom, interpreted code, the execution of which causes the T&M application to display a custom analysis window within the GUI.

What is claimed is:

1. A computer program distributed by a first party, comprising:
code to determine whether a second party has defined a custom analysis of test and measurement (T&M) data and then provide user access to the custom analysis via a graphical user interface (GUI); and
code to, upon a user's selection of the custom analysis via the GUI, i) execute custom code provided by the second party, and ii) display the custom analysis within a window of the GUI, in a format dictated by the execution of the custom code.

2. The computer program of claim 1, further comprising:
code to provide user access to a standard analysis via the GUI; and
code to, upon a user's selection of the standard analysis via the GUI, display the standard analysis within a window of the GUI.

3. The computer program of claim 2, wherein the custom analysis and standard analysis are displayed within different windows of the GUI.

4. The computer program of claim 3, wherein the different windows in which the custom analysis and standard analysis are displayed have a common look-and-feel.

5. The computer program of claim 2, wherein the custom code is interpreted code, and wherein the standard analysis is displayed in response to the execution of compiled code.

6. The computer program of claim 1, further comprising:
code to provide, via the GUI, user access to properties for the custom analysis; and
code to, upon a user's selection of the properties via the GUI, display the properties in a dialog box as dictated by the execution of the custom code.

7. The computer program of claim 1, further comprising:
code to provide a means to launch a custom analysis creation tool from within said GUI; and
code to, upon the second party's selection of the custom analysis creation tool, provide an interface for specifying and saving said custom code.

8. The computer program of claim 7, wherein the custom code comprises Visual Basic for Applications (VBA) code.

9. The computer program of claim 1, further comprising code to i) receive events regarding updates of T&M data, and ii) provide notifications of at least some of the events to the window that displays the custom analysis.

10. The computer program of claim 1, wherein the format of the custom analysis specifies a T&M graph.

11. The computer program of claim 1, further comprising code to retrieve data from T&M equipment.

12. The computer program of claim 11, further comprising code to, upon a user's selection of the custom analysis via the GUI, launch the code to retrieve data from the T&M equipment, in accordance with parameters defined by the custom code.

13. The computer program of claim 1, wherein the T&M data comprises logic analyzer data.

14. The computer program of claim 1, wherein the custom code comprises Visual Basic for Applications (VBA) code.

15. A method of enabling a test and measurement (T&M) application to display a custom analysis of T&M data, comprising:
providing the T&M application with a plurality of display elements, including:
a first window type for displaying a standard analysis of the T&M data;
an interface for specifying and saving custom code that defines said custom analysis; and
a second window type for displaying the custom analysis in a format dictated by execution of the custom code; and
providing the T&M application with at least one graphical user interface (GUI) via which said display elements may be selected and displayed.

16. The method of claim 1, wherein the interface for specifying and saving custom code implements Visual Basic for Applications (VBA).

17. The method of claim 1, further comprising, providing the first and second window types with a common look-and-feel.

18. The method of claim 15, further comprising, providing the T&M application with an ability to launch multiple instances of the first and second window types, with each launched instance displaying a different standard or custom analysis of the T&M data.

19. A method for displaying a custom analysis of test and measurement (T&M) data, comprising:
choosing from between a custom analysis and a standard analysis that are selectable via a graphical user interface (GUI) of a T&M application;
upon selection of the standard analysis, causing the T&M application to execute compiled code, the execution of which causes the T&M application to display a standard analysis window within the GUI; and
upon selection of the custom analysis, causing the T&M application to execute custom, interpreted code, the execution of which causes the T&M application to display a custom analysis window within the GUI.

20. The method of claim 19, wherein the custom, interpreted code is Visual Basic for Applications (VBA) code.
